(19) United States
(12) Patent Application Publication
(10) Pub. No.: US 2024/0171353 A1
(43) Pub. Date: May 23, 2024

(54) Parameter Determination Method, Device, and Non-Transitory Readable Storage Medium

(71) Applicant: VIVO MOBILE COMMUNICATION CO., LTD., Dongguan (CN)

(72) Inventors: Yu Yang, Dongguan (CN); Peng Sun, Dongguan (CN)

(21) Appl. No.: 18/424,981

(22) Filed: Jan. 29, 2024

Related U.S. Application Data
(63) Continuation of application No. PCT/CN2022/109176, filed on Jul. 29, 2022.

(30) Foreign Application Priority Data
Jul. 30, 2021 (CN) 202110875303.8

(51) Int. Cl. H04L 5/00

(52) U.S. Cl. CPC H04L 5/0053

(57) ABSTRACT

A parameter determining method includes determining configuration information of an SRS in a unified transmission configuration indicator framework, where the configuration information of the SRS includes at least one of beam information of the SRS or power control parameter information of the SRS.

### CROSS-REFERENCE TO RELATED APPLICATIONS

This application is a Bypass Continuation application of International Patent Application No. PCT/CN2022/109176, filed Jul. 29, 2022, and claims priority to Chinese Patent Application No. 202110875303.8, filed Jul. 30, 2021, the disclosures of which are hereby incorporated by reference in their entireties.

### BACKGROUND OF THE INVENTION

### Field of the Invention

This application pertains to the field of communications technologies, and in particular, to a parameter determining method and apparatus, and a device.

### Description of Related Art

In the R17 (Release 17) protocol of new radio (NR), a concept of unified transmission configuration indicator framework (unified TCI framework) is introduced.

The R17 unified TCI framework defines that a network device can indicate common beam information to a terminal device through downlink signaling, for example, a joint transmission configuration indicator state (joint TCI state) or a separate UL TCI state, to determine common beam information of a plurality of channels or reference signals.

### SUMMARY OF THE INVENTION

According to a first aspect, a parameter determining method is provided, and the method includes: determining configuration information of an SRS in a unified transmission configuration indicator framework, where the configuration information of the SRS includes at least one of beam information of the SRS or power control (PC) parameter information of the SRS.

According to a second aspect, a parameter determining apparatus is provided, and the apparatus includes a determining module. The determining module is configured to determine configuration information of an SRS in a unified transmission configuration indicator framework, where the configuration information of the SRS includes at least one of beam information of the SRS or power control parameter information of the SRS.

According to a third aspect, a terminal device is provided, where the terminal device includes a processor, a memory, and a program or an instruction stored in the memory and executable on the processor, and when the program or the instruction is executed by the processor, steps of the parameter determining method according to the first aspect are implemented.

According to a fourth aspect, a terminal device is provided, including a processor and a communications interface. The processor is configured to determine configuration information of an SRS in a unified transmission configuration indicator framework, where the configuration information of the SRS includes at least one of beam information of the SRS or power control parameter information of the SRS.

According to a fifth aspect, a non-transitory readable storage medium is provided, where the non-transitory readable storage medium stores a program or an instruction, and when the program or the instruction is executed by a processor, steps of the parameter determining method according to the first aspect are implemented.

According to a sixth aspect, a chip is provided, including a processor and a communications interface. The communications interface is coupled to the processor, and the processor is configured to run a program or an instruction to implement the parameter determining method according to the first aspect.

According to a seventh aspect, a computer program/program product is provided, where the computer program/program product is stored in a non-volatile storage medium, and the program/program product is executed by at least one processor to implement steps of the parameter determining method according to the first aspect.

### BRIEF DESCRIPTION OF THE DRAWINGS

FIG. 1 is a block diagram of a wireless communications system to which the embodiments of this application can be applied;

FIG. 2 is a flowchart of a parameter determining method according to an embodiment of this application;

FIG. 3 is a schematic diagram of a structure of a parameter determining apparatus according to an embodiment of this application;

FIG. 4 is a schematic diagram of a communications device according to an embodiment of this application; and

FIG. 5 is a schematic diagram of a hardware structure of a terminal device according to an embodiment of this application.

### DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communications systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. An NR system is described in the following description for illustrative purposes, and NR terms are used in most of the following description, although these technologies can also be applied to applications other than the NR system application, such as the 6-th generation (6G) communications system.

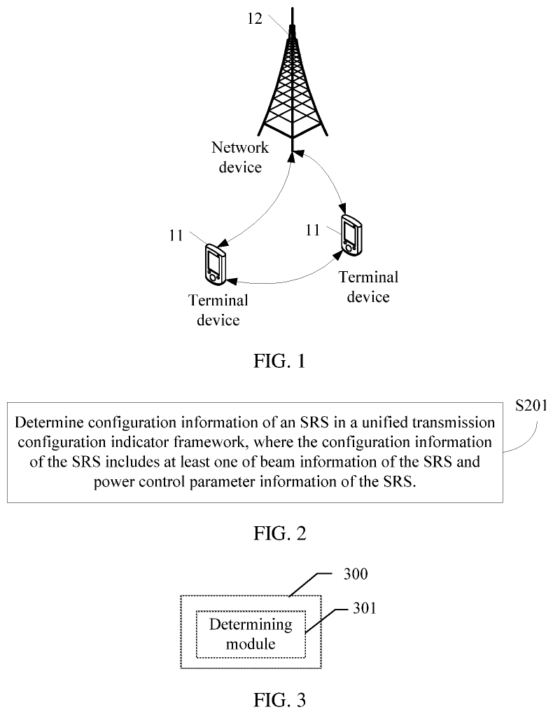

FIG. 1 is a block diagram of a wireless communications system to which embodiments of this application can be applied. The wireless communications system includes a terminal device 11 and a network device 12. The terminal device 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), smart household (household devices with wireless communications functions, such as a refrigerator, a television, a washing machine, or furniture), and the wearable device include a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, a game console, and the like. It should be noted that a type of the terminal device 11 is not limited in the embodiments of this application. The network device 12 may be a base station or a core network. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a WLAN access point, a Wi-Fi node, a transmitting receiving point (TRP), or another suitable term in the field provided that a same technical effect is achieved. The base station is not limited to a technical term. It should be noted that, in the embodiments of this application, only a base station in an NR system is used as an example, but a type of the base station is not limited.

Currently, during beam measurement, the network device may configure a reference signal resource set (RS resource set), including at least one reference signal resource (RS resource), such as a synchronization signal and PBCH block (SSB) resource or a CSI reference signal (CSI-RS) resource. The UE may measure an Layer 1 reference signal received power (L1-RSRP)/L1 signal-to-noise and interference ratio (L1-SINR) of each RS resource, and report at least one optimal measurement result to the network device.

After beam measurement and beam reporting are performed, the network device may perform beam indication on downlink and uplink channels or reference signals, to establish a beam link between the network device and the terminal device, thus realizing transmission of channels or reference signals.

In the protocol before R17, beam indication of the sounding reference signal (SRS) includes three methods: when a type of the SRS is a periodic SRS, the network device configures spatial relation information for the SRS resource through radio resource control (RRC) signaling. When the type of the SRS is a semi-persistent SRS or an aperiodic SRS, the network device configures the spatial relation information for the SRS resource through the RRC signaling, and updates the spatial relation information of the SRS resource by using a MAC CE command.

In the protocol before R17, a power control parameter of the SRS is determined as follows: for a path loss reference signal (PL-RS or PLRS), a PLRS configured by the RRC is used, or a PLRS configured by the RRC and updated by the MAC CE is used. A target received power P0, a path loss compensation factor (a or alpha), a closed loop power control index, a closed loop index (CLI), or the like is determined based on a parameter configured for each SRS resource set, and the parameter can be updated or reconfigured through the RRC.

A concept of a unified transmission configuration indicator framework is introduced in the R17 protocol, a transmission configuration indicator state pool (TCI state pool) is set in the frame, and it is defined that a network device may indicate common beam information to a terminal device through a MAC CE or downlink control information (DCI). The common beam information is used for a plurality of channels or reference signals, and the common beam information is selected by the network device from the TCI state pool. The common beam information can be a joint TCI state, a separate DL TCI state, or a separate UL TCI state. The joint TCI state is used to determine beam information of a UE-specific control channel and data channel, the separate DL TCI state is used to determine beam information of a UE-specific control channel and data channel in a downlink, and the separate UL TCI state is used to determine beam information of a control channel and a data channel in an uplink.

The unified transmission configuration indicator framework further defines a method for determining the power control parameter. For example, the PLRS can be configured in the UL TCI state or the joint TCI state, or associated with the UL TCI state or the joint TCI state. A power control parameter set other than the PLRS, for the PUCCH or the PUSCH, is associated with the UL TCI state or the joint TCI state.

The common beam information indicated by the joint TCI state or the separate UL TCI state and power control parameter information included in or associated with the common beam information are used for a plurality of channels such as a physical uplink shared channel (PUSCH) and a physical uplink control channel (PUCCH).

However, at present, it is not specified in the unified transmission configuration indicator framework whether the SRS adopts the method for determining the beam information and the power control parameter, that is, the R17 unified TCI framework does not currently provide a method for determining configuration information such as beam information and power control parameter information of the SRS. Therefore, this application provides a parameter determining method and apparatus, and a device, which provides the method for determining the beam information of the SRS and the power control parameter information of the SRS in the unified transmission configuration indicator framework. It should be noted that the parameter determining method and apparatus, and a device provided in the embodiments of this application are not limited to the R17 protocol, but can also be applied to other protocols after the R17.

It should be noted that, the beam information mentioned in the embodiments of this embodiment may also be referred to as identification information of a beam, spatial relation information, spatial domain transmission filter information, spatial domain reception filter information, spatial filter information, transmission configuration indicator state (TCI state) information, quasi co-location (QCL) information, a QCL parameter, or the like. Downlink beam information can usually be represented by TCI state information or QCL information, and uplink beam information can usually be represented by TCI state information or spatial relation information.

With reference to the accompanying drawings, a parameter determining method and apparatus, and a device provided in the embodiments of this application are described in detail by using some embodiments and application scenarios thereof.

As shown in FIG. 2, an embodiment of this application provides a parameter determining method. The parameter determining method may be applied to a terminal device. The parameter determining method may include the following S201.

S201. Determine configuration information of an SRS in a unified transmission configuration indicator framework, where the configuration information of the SRS includes at least one of beam information of the SRS or power control parameter information of the SRS.

Optionally, the beam information of the SRS may be any one of the following:
a spatial filter for uplink transmission of an SRS resource;
a reference signal of the SRS resource; and
a source reference signal of the SRS resource.

Optionally, the SRS includes any one of the following purposes:
an SRS for antenna switching;
an SRS for codebook-based uplink transmission (codebook-based UL transmission);
an SRS for non-codebook based uplink transmission (non-codebook based UL transmission); and
an SRS for beam management.

That is, the SRS can be used for any one of antenna switching, codebook-based uplink transmission, non-codebook based uplink transmission, and beam management.

Optionally, the power control parameter information of the SRS includes at least one of a path loss reference signal (PL-RS or PLRS) or a power control parameter group (setting).

The power control parameter set may include a power control parameter set other than the PLRS.

For example, the power control parameter group may include at least one of the following:
a target received power P0;
a path loss compensation factor (α or alpha);
a closed loop power control index or a closed loop index (CLI); or
a power control adjustment state value.

The target received power P0 is a power expected to reach a base station; a value of the path loss compensation factor α determines whether the circuit loss is fully or partially compensated when the power is calculated; the closed loop power control index (also referred to as a closed loop power control process) is used to indicate a closed loop power control adjustment state that the SRS can maintain, and a value determines a process identifier of closed loop power control; and the power control adjustment state value is divided into an accumulation mode and an absolute assignment mode. The closed loop power control adjustment state index is used to indicate the closed loop power control adjustment state that the SRS can maintain.

For the unified transmission configuration indicator framework, the configuration information of the SRS can be determined by using a target method. The target method at least includes at least one of the following:
A. using common configuration information indicated by a network device, where the common configuration information can further be used for a PUCCH and/or a PUSCH;
B. using first configuration information different from the common configuration information;
C. using configuration information of the SRS in an SRS resource set indicated by a first MAC CE;
D. using configuration information of the SRS indicated by the first MAC CE; or
E. using configuration information determined in relevant methods, such as using configuration information determined by using a relevant protocol (such as R15 and/or R16) before the R17.

It should be noted that the manner A to the manner E are examples for description, which does not limit the embodiments of this application. It can be understood that the configuration information of the SRS can also be determined in any other possible manner. For example, other manners among three optional implementations provided in the following embodiment are used, and details are not described herein.

In a case that the configuration information of the SRS is separately the beam information of the SRS, the PLRS of the SRS, and the power control parameter group of the SRS, three optional implementations will be provided as examples for description.

First Optional Implementation

In a case that the configuration information of the SRS includes the beam information of the SRS, the beam information of the SRS can be determined based on any one of the following.

A1. Use common beam information indicated by a network device, where the common beam information is further used for a PUCCH and/or a PUSCH.

For example, it is configured by a network or specified in a protocol that the SRS uses uplink beam information the same as that of the PUCCH and/or the PUSCH. The uplink beam information can be selected by the network device from the TCI state pool, such as a UL TCI state or a joint TCI state indicated in the TCI state pool through the MAC CE or DCI.

B1. Use first beam information different from the common beam information, where the first beam information and the common beam information are selected by the network device from a TCI state pool.

For example, it is configured by a network or specified in a protocol that the SRS uses the first beam information different from beam information of the PUCCH and/or the PUSCH, and the first beam information and the beam information of the PUCCH and/or the PUSCH are selected by the network device from the TCI state pool.

C1. Use beam information of the SRS that is in an SRS resource set and that is indicated by a first MAC CE.

For example, the first MAC CE includes beam information (TCI state or spatial relation) of each SRS resource in the SRS resource set.

D1. Use beam information of the SRS indicated by the first MAC CE.

For example, the first MAC CE includes a resource index of at least one SRS resource and corresponding beam information thereof (such as a TCI state or a spatial relation).

E1. Use spatial relation information indicated by RRC or a second MAC CE.

For example, the network device may indicate the beam information of the SRS by using a relevant protocol before the R17 (for example, R15 and/or R16). For example, when a type of the SRS is a periodic SRS, the network device configures spatial relation information for the SRS resource through RRC signaling; and when the type of the SRS is a semi-persistent SRS or an aperiodic SRS, the network device configures the spatial relation information for the SRS resource through the RRC signaling, and updates the spatial relation information of the SRS resource by using a MAC CE command.

In this embodiment of this application, because a plurality of methods for determining the beam information of the SRS are provided, after the terminal device determines the beam information of the SRS, the network device and the terminal device can have consistent understanding for the beam of the SRS, and establish a beam link based on the beam information, thereby realizing transmission of a channel or a reference signal and ensuring beam alignment.

Second Optional Implementation

In a case that the configuration information of the SRS includes power control parameter information of the SRS, and the power control parameter information of the SRS includes the PLRS of the SRS, the PLRS of the SRS can be determined based on any one of the following.

A2. Use a first PLRS, where the first PLRS is configured in common beam information indicated by a network device or is associated with the common beam information, and the first PLRS is further used for a PUCCH and/or a PUSCH.

For example, it is configured by a network or specified in a protocol that the SRS uses the first PLRS the same as that of the PUCCH and/or the PUSCH. The first PLRS is configured in common beam information indicated by a network device or is associated with the common beam information. The common beam information is selected by the network device from a TCI state pool. For example, the SRS uses the beam information the same as that of the PUCCH and/or the PUSCH, and also uses the PLRS that is the same as that of the PUCCH and/or the PUSCH and that is included in or associated with the common beam information.

B2. Use a second PLRS, where the second PLRS is configured in the common beam information or is associated with the common beam information, and the second PLRS is different from the first PLRS.

For example, it is configured by a network or specified in a protocol that the SRS uses the second PLRS that is different from the first PLRS of the PUCCH and/or the PUSCH. The first PLRS and the second PLRS are configured in the common beam information or are associated with the common beam information. The common beam information is selected by the network device from a TCI state pool. For example, the SRS can use beam information the same as that of the PUCCH and/or the PUSCH, but the common beam information includes or is associated with a plurality of PLRSes, where the first PLRS is used for the PUCCH and/or the PUSCH, and the second PLRS is used for the SRS.

C2. Use a third PLRS, where the third PLRS is configured in first beam information or is associated with the first beam information, the first beam information is different from the common beam information, and the first beam information and the common beam information are selected by the network device from a TCI state pool.

For example, it is configured by a network or specified in a protocol that the SRS uses the third PLRS that is configured in the first beam information or that is associated with the first beam information. The first beam information is different from the common beam information, and the first beam information and the common beam information are selected by the network device from a TCI state pool.

D2. Use a PLRS of the SRS in an SRS resource set indicated by a first MAC CE.

For example, the first MAC CE includes a PLRS corresponding to the SRS resource set or a PLRS corresponding to the SRS resource in the SRS resource set.

E2. Use a PLRS of the SRS indicated by the first MAC CE.

For example, the first MAC CE includes a resource index of at least one SRS resource and a PLRS corresponding to the at least one SRS resource.

F2. Use a PLRS configured by RRC, or using a PLRS configured by the RRC and updated by a MAC CE.

For example, the network device may indicate the PLRS of the SRS by using a relevant protocol before the R17 (for example, R15 and/or R16). For example, using a PLRS configured by RRC, or using a PLRS configured by the RRC and updated by a MAC CE.

G2. A PLRS that is determined based on whether the common beam information is used, where the common beam information is further used for the PUCCH and/or the PUSCH.

It should be noted that “the PLRS that is determined based on whether the common beam information is used” refers to a PLRS determined by using any one of A2 to F2.

For example, it is configured by a network or specified in a protocol that the PLRS of the SRS is determined based on whether the common beam information is used: if the SRS uses the common beam information, the PLRS is determined by using Example 1 to Example 3 in the following embodiment; and if the SRS does not use the common beam information, the PLRS is determined by using Example 4 to Example 6 in the following embodiment.

In this embodiment of this application, because a plurality of methods for determining the PLRS of the SRS are provided, the network device and the terminal device can have consistent understanding for the PLRS, thus ensuring correct data transmission and ensuring accuracy of power control.

Third Optional Implementation

In a case that the configuration information of the SRS includes power control parameter information of the SRS, and the power control parameter information of the SRS includes the power control parameter group of the SRS, the power control parameter group of the SRS can be determined based on any one of the following.

A3. Use a first power control parameter group, where the first power control parameter group is configured in common beam information indicated by a network device or is associated with the common beam information, and the first power control parameter group is further used for a PUCCH and/or a PUSCH.

For example, it is configured by a network or specified in a protocol that the SRS uses the first power control parameter group the same as that of the PUCCH and/or the PUSCH. The power control parameter group is configured in common beam information indicated by a network device or is associated with the common beam information. The common beam information is selected by the network device from a TCI state pool. For example, the SRS uses the beam information the same as that of the PUCCH and/or the PUSCH, and also uses the power control parameter group that is the same as that of the PUCCH and/or the PUSCH and that is included in or associated with the common beam information.

B3. Use a second power control parameter group, where the second power control parameter group is configured in the common beam information or is associated with the common beam information, and the second power control parameter group is different from the first power control parameter group.

For example, it is configured by a network or specified in a protocol that the SRS uses the second power control parameter group that is different from the first power control parameter group of the PUCCH and/or the PUSCH. The first power control parameter group and the second power control parameter group are configured in the common beam information or are associated with the common beam information. The common beam information is selected by the network device from a TCI state pool. For example, the SRS can use beam information the same as that of the PUCCH and/or the PUSCH, but the common beam information includes or is associated with a plurality of power control parameter groups, where a first power control parameter group is used for the PUCCH and/or the PUSCH, and a second power control parameter group is used for the SRS.

C3. Use a third power control parameter group, where the third power control parameter group is configured in first beam information or is associated with the first beam information, the first beam information is different from the common beam information, and the first beam information and the common beam information are selected by the network device from a TCI state pool.

For example, it is configured by a network or specified in a protocol that the SRS uses the third power control parameter group that is configured in the first beam information or that is associated with the first beam information. The first beam information is different from the common beam information, and the first beam information and the common beam information are selected by the network device from a TCI state pool.

D3. Use a power control parameter group of the SRS in an SRS resource set indicated by a first MAC CE.

For example, the first MAC CE includes a power control parameter group corresponding to the SRS resource set or a power control parameter group corresponding to the SRS resource in the SRS resource set.

E3. Use a power control parameter group of the SRS indicated by the first MAC CE.

For example, the first MAC CE includes a resource index of at least one SRS resource and a power control parameter group corresponding to the at least one SRS resource.

F3. Use a power control parameter group configured by RRC.

For example, the network device may indicate the power control parameter group of the SRS by using a protocol before the R17 (for example, R15 and/R16). For example, using a power control parameter such as a target received power P0 and a path loss compensation factor α in the power control parameter group configured by RRC.

G3. A power control parameter group that is determined based on whether the common beam information is used, where the common beam information is further used for the PUCCH and/or the PUSCH.

It should be noted that “the power control parameter group that is determined based on whether the common beam information is used” refers to a power control parameter group determined by using any one of A3 to F3.

For example, it is configured by a network or specified in a protocol that the power control parameter group of the SRS is determined based on whether the common beam information is used: if the SRS uses the common beam information, the power control parameter group is determined by using Example 1 to Example 3 in the following embodiment; and if the SRS does not use the common beam information, the power control parameter group is determined by using Example 4 to Example 6 in the following embodiment.

In this embodiment of this application, because a plurality of methods for determining the power control parameter group of the SRS are provided, the network device and the terminal device can have consistent understanding for the power control parameter group of the SRS, thus ensuring correct data transmission and ensuring accuracy of power control.

Optionally, for the PUCCH in the three optional implementations, the PUCCH is all of PUCCHs or a part of the PUCCHs, that is, the PUCCH refers to all or a part of PUCCH resources.

Optionally, for the PUSCH in the three optional implementations, the PUSCH is a dynamic grant PUSCH or a configured grant PUSCH.

Optionally, for the common beam information in the three optional implementations, the common beam information is uplink beam information, and the uplink beam information is a UL TCI state or a joint TCI state indicated through a MAC CE or DCI.

Optionally, for the first MAC CE in the three optional implementations, the first MAC CE can be used to indicate at least one of the following:
identification information of the SRS resource set;
beam information of the SRS resource set;
a PLRS of the SRS resource set;
a power control parameter group of the SRS resource set;
index information of at least one SRS resource;
beam information of at least one SRS resource;
a PLRS of at least one SRS resource;
a power control parameter group of at least one SRS resource;
a type of the SRS; or
a reference signal type.

The beam information of the SRS resource set, the PLRS of the SRS resource set, and the power control parameter group of the SRS resource set are used for all SRS resources in the SRS resource set. For example, all SRS resources in the SRS resource set use the beam information, the PLRS, and the power control parameter group of the SRS resource set.

For example, the first MAC CE can introduce a new indication function for the CSI-RS, such as indicating beam information of the CSI-RS (in the related art, only beam information of a semi-persistent CSI-RS can be indicated through a MAC CE, and beams of a periodic or aperiodic CSI-RS are all configured by the RRC). Therefore, the MAC CE for the SRS and the MAC CE for the CSI-RS can be the same. In this case, it is necessary to indicate whether the RS type is the CSI-RS or the SRS in the first MAC CE, that is, the first MAC CE is used to indicate a reference signal type.

To illustrate this application more clearly, this embodiment of this application further provides the following seven examples to illustrate the parameter determining method provided in this application.

### Example 1

i. Determine the beam information of the SRS

Use common beam information indicated by a network device, where the common beam information is further used for a PUCCH and/or a PUSCH. For example, it is configured by a network or specified in a protocol that the SRS uses uplink beam information the same as that of the PUCCH and/or the PUSCH.

The PUCCH is all of or a part of PUCCH resources.

The PUSCH is a dynamic grant PUSCH or a configured grant PUSCH.

The uplink beam information is a UL TCI state or a joint TCI state indicated by the network device through a MAC CE or DCI.

ii. Determine the PLRS of the SRS

Use a first PLRS, where the first PLRS is configured in common beam information indicated by a network device or is associated with the common beam information, and the first PLRS is further used for a PUCCH and/or a PUSCH. For example, it is configured by a network or specified in a protocol that the SRS uses the PLRS the same as that of the PUCCH and/or the PUSCH.

iii. Determine setting information of the SRS

Use a first power control parameter group, where the first power control parameter group is configured in common beam information indicated by a network device or is associated with the common beam information, and the first power control parameter group is further used for a PUCCH and/or a PUSCH. For example, it is configured by a network or specified in a protocol that setting configured in the beam information or associated with the beam information is used, and the setting is also used for the PUCCH and/or the PUSCH.

CLI in the setting can be determined, based on network configuration, whether to be applied to the SRS.

For example, a TCI state is associated with the power control parameter group, and a TCI state ID—{P0, alpha, CLI} is used for the PUCCH and the SRS, or used for the PUSCH and the SRS, or used for the PUCCH, the PUSCH, and the SRS.

### Example 2

i. Determine the Beam Information of the SRS

Use common beam information indicated by a network device, where the common beam information is further used for a PUCCH and/or a PUSCH. For example, it is configured by a network or specified in a protocol that the SRS uses uplink beam information the same as that of the PUCCH and/or the PUSCH.

ii. Determine the PLRS of the SRS

1. Use a first PLRS, where the first PLRS is configured in common beam information indicated by a network device or is associated with the common beam information, and the first PLRS is further used for a PUCCH and/or a PUSCH. For example, it is configured by a network or specified in a protocol that the PLRS the same as that of the PUCCH and/or the PUSCH is used.

2. Alternatively, a PLRS configured by RRC is used, or a PLRS configured by the RRC and updated by a MAC CE is used. That is, the network device indicates the PLRS of the SRS by using a relevant protocol before the R17 (for example, R15 and/or R16).

iii. Determine Setting Information of the SRS

Use a second power control parameter group, where the second power control parameter group is configured in the common beam information or is associated with the common beam information, and the second power control parameter group is different from the first power control parameter group. For example, it is configured by a network or specified in a protocol that setting configured in the beam information or associated with the beam information is used, and the setting is different from setting of the PUCCH and the PUSCH.

CLI in the setting of the SRS can be determined, based on network configuration, whether to be applied to the SRS.

For example,
the TCI state is associated with a power control parameter group.

If TCI state ID-PC setting ID {P01, alpha0, CLI1, P02, alpha2, CLI2, P03, alpha3, CLI3}, then P01, alpha0, and CLI1 are used for PUCCH, P02, alpha2, and CLI2 are used for PUSCH, and P03, alpha3, and CLI3 are used for SRS.

Alternatively,
if TCI state ID 1—PC setting ID 1 {P01, alpha0, CLI1}, used for PUCCH;
if TCI state ID 2—PC setting ID 2 {P02, alpha2, CLI2}, used for PUSCH; and
if TCI state ID 3—PC setting ID 3 {P03, alpha3, CLI3}, used for SRS.

It should be noted that although TCI state IDs are different, corresponding beams are the same, that is, a same uplink common beam is used.

### Example 3

i. Determine the Beam Information of the SRS

Use common beam information indicated by a network device, where the common beam information is further used for a PUCCH and/or a PUSCH. For example, it is configured by a network or specified in a protocol that the SRS uses uplink beam information the same as that of the PUCCH and/or the PUSCH.

ii. Determine the PLRS of the SRS

1. Use a first PLRS, where the first PLRS is configured in common beam information indicated by a network device or is associated with the common beam information, and the first PLRS is further used for a PUCCH and/or a PUSCH. For example, it is configured by a network or specified in a protocol that the PLRS the same as that of the PUCCH and/or the PUSCH is used.

2. Alternatively, a PLRS configured by RRC is used, or a PLRS configured by the RRC and updated by a MAC CE is used. That is, the network device indicates the PLRS of the SRS by using a relevant protocol before the R17 (for example, R15 and/or R16).

iii. Determine Setting Information of the SRS

Use a power control parameter group configured by RRC. That is, the network device uses a protocol before the R17 to determine setting information of the SRS, for example, RRC configures set setting of the SRS resource set, and P0, alpha, and CLI in the setting information are applied to all SRS resources in the SRS resource set.

### Example 4

i. Determine the Beam Information of the SRS

The network device uses beam information of the SRS indicated by the first MAC CE. For example, the first MAC CE includes beam information (for example, a TCI state or a spatial relation) of each SRS resource in the SRS resource set.

ii. Determine the PLRS of the SRS

1. The network device uses a PLRS of the SRS indicated by the first MAC CE. For example, the first MAC CE includes a PLRS corresponding to the SRS resource set or a PLRS corresponding to the SRS resource in the SRS resource set.

2. Alternatively, a PLRS configured by RRC is used, or a PLRS configured by the RRC and updated by a MAC CE is used. That is, the network device may indicate the PLRS of the SRS by using a relevant protocol before the R17 (for example, R15 and/or R16). For example, using a PLRS configured by RRC, or using a PLRS configured by the RRC and updated by a MAC CE.

iii. Determine Setting Information of the SRS

1. The network device uses setting information of the SRS indicated by the first MAC CE.

It should be noted that all parameters in the setting information can be defaulted, or only CLI can be defaulted.

For example, the first MAC CE includes P0, alpha, and CLI corresponding to the SRS resource set, or includes P0, alpha, and CLI corresponding to the SRS resource in the SRS resource set.

2. Alternatively, a power control parameter group configured by RRC is used. That is, the network device may indicate the power control parameter group of the SRS by using a relevant protocol before the R17 (for example, R15 and/or R16), for example, using a target received power P0 and a path loss compensation factor α in the power control parameter group configured by RRC.

### Example 5

i. Determine the Beam Information of the SRS

Spatial relation information indicated by the network device by using RRC or a second MAC CE. That is, the network device may indicate beam information of the SRS by using a relevant protocol before the R17 (for example, R15 and/or R16).

Reference may be made to the description in the foregoing embodiment, and details are not repeated herein again.

ii. Determine the PLRS of the SRS

1. The network device uses a PLRS of the SRS indicated by the first MAC CE.

For example, the first MAC CE includes a PLRS corresponding to the SRS resource set or a PLRS corresponding to the SRS resource in the SRS resource set.

2. Alternatively, a PLRS configured by RRC is used, or a PLRS configured by the RRC and updated by a MAC CE is used. That is, the network device may indicate the PLRS of the SRS by using a relevant protocol before the R17 (for example, R15 and/or R16).

iii. Determine Setting Information of the SRS

Use setting information configured by RRC. That is, the network device may indicate setting information of the SRS by using a relevant protocol before the R17 (for example, R15 and/or R16).

### Example 6

i. Determine the Beam Information of the SRS

Spatial relation information indicated by the network device by using RRC or a second MAC CE. That is, the network device may indicate beam information of the SRS by using a relevant protocol before the R17 (for example, R15 and/or R16).

Reference may be made to the description in the foregoing embodiment, and details are not repeated herein again.

ii. Determine the PLRS of the SRS

1. The network device uses a PLRS of the SRS indicated by the first MAC CE.

For example, the first MAC CE includes a PLRS corresponding to the SRS resource set or a PLRS corresponding to the SRS resource in the SRS resource set.

2. Alternatively, a PLRS configured by RRC is used, or a PLRS configured by the RRC and updated by a MAC CE is used. That is, the network device may indicate the PLRS of the SRS by using a relevant protocol before the R17 (for example, R15 and/or R16).

iii. Determine Setting Information of the SRS

1. The network device uses setting information of the SRS indicated by the first MAC CE.

It should be noted that all parameters in the setting information can be defaulted, or only CLI can be defaulted.

For example, the first MAC CE includes P0, alpha, and CLI corresponding to the SRS resource set or P0, alpha, and CLI corresponding to the SRS resource in the SRS resource set.

2. Alternatively, use setting information configured by RRC. That is, the network device may indicate setting information of the SRS by using a relevant protocol before the R17 (for example, R15 and/or R16).

### Example 7

1. Determine power control parameter information based on whether the common beam information is used, where the common beam information is further used for the PUCCH and/or the PUSCH.

It should be noted that “determine power control parameter information based on whether the common beam information is used” refers to that it is configured by a network or specified in a protocol whether the SRS uses uplink beam information the same as that of the PUCCH and/or the PUSCH.

2. If the SRS uses beam information the same as that of the PUCCH and/or the PUSCH, the power control parameter information can be determined by using any one of Example 1 to Example 3.

3. If the SRS does not use beam information the same as that of the PUCCH and the PUSCH, the power control parameter information can be determined by using any one of Example 4 to Example 6.

In Example 1 to Example 6, when the SRS does not use the beam information the same as that of the PUCCH and/or the PUSCH, the TCI state or spatial relation indicated by the network device for the SRS is determined based on any one of the following:
i. candidate beam information pool based on the R17, such as an R17 TCI state pool; and
ii. beam information directly indicated based on a manner of R15 and/or R16, for example, the RRC or the MAC CE is used to indicate a spatial relation of the SRS resource.

CLI in Example 1 to Example 6 can also be understood as a power control adjustment state value.

It should be noted that the parameter determining method provided in this embodiment of this application may be performed by a parameter determining apparatus, or a control module that is in the parameter determining apparatus and that is configured to perform the parameter determining method. In this embodiment of this application, that the parameter determining apparatus performs the parameter determining method is used as an example to describe the parameter determining apparatus provided in the embodiments of this application.

As shown in FIG. 3, an embodiment of this application provides a parameter determining apparatus 300. The parameter determining apparatus includes a determining module 301. The determining module 301 may be configured to determine configuration information of an SRS in a unified transmission configuration indicator framework, where the configuration information of the SRS includes at least one of beam information of the SRS or power control parameter information of the SRS.

Optionally, the configuration information of the SRS includes the beam information of the SRS. The beam information of the SRS is determined based on any one of the following:
using common beam information indicated by a network device, where the common beam information is further used for a PUCCH and/or a PUSCH;
using first beam information different from the common beam information, where the first beam information and the common beam information are selected by the network device from a transmission configuration indicator state pool;
using beam information of the SRS in an SRS resource set indicated by a first MAC CE;
using beam information of the SRS indicated by the first MAC CE; and
using spatial relation information indicated by RRC or a second MAC CE.

Optionally, the configuration information of the SRS includes power control parameter information of the SRS. The power control parameter information of the SRS includes the PLRS of the SRS. The PLRS of the SRS is determined based on any one of the following:
using a first PLRS, where the first PLRS is configured in common beam information indicated by a network device or is associated with the common beam information, and the first PLRS is further used for a PUCCH and/or a PUSCH;
using a second PLRS, where the second PLRS is configured in the common beam information or is associated with the common beam information, and the second PLRS is different from the first PLRS;
using a third PLRS, where the third PLRS is configured in first beam information or is associated with the first beam information, the first beam information is different from the common beam information, and the first beam information and the common beam information are selected by the network device from a transmission configuration indicator state pool;
using a PLRS of the SRS in an SRS resource set indicated by a first MAC CE;
using a PLRS of the SRS indicated by the first MAC CE;
using a PLRS configured by RRC, or using a PLRS configured by the RRC and updated by a MAC CE; and
a PLRS that is determined based on whether the common beam information is used, where the common beam information is further used for the PUCCH and/or the PUSCH.

Optionally, the configuration information of the SRS includes power control parameter information of the SRS. The power control parameter information of the SRS includes the power control parameter group of the SRS. The power control parameter group includes at least one of the following: a target received power P0, a path loss compensation factor α, a closed loop power control index, or a power control adjustment state value. The power control parameter group of the SRS is determined based on any one of the following:
using a first power control parameter group, where the first power control parameter group is configured in common beam information indicated by a network device or is associated with the common beam information, and the first power control parameter group is further used for a PUCCH and/or a PUSCH;
using a second power control parameter group, where the second power control parameter group is configured in the common beam information or is associated with the common beam information, and the second power control parameter group is different from the first power control parameter group;
using a third power control parameter group, where the third power control parameter group is configured in first beam information or is associated with the first beam information, the first beam information is different from the common beam information, and the first beam information and the common beam information are selected by the network device from a transmission configuration indicator state pool;
using a power control parameter group of the SRS in an SRS resource set indicated by a first MAC CE;
using a power control parameter group of the SRS indicated by the first MAC CE;
using a power control parameter group configured by RRC; and
a power control parameter group that is determined based on whether the common beam information is used, where the common beam information is further used for the PUCCH and/or the PUSCH.

Optionally, the PUCCH is all of PUCCHs or a part of the PUCCHs.

Optionally, the PUSCH is a dynamic grant PUSCH or a configured grant PUSCH.

Optionally, the common beam information is uplink beam information, and the uplink beam information is a separate UL TCI state or a joint transmission configuration indicator state indicated through a MAC CE or DCI.

Optionally, the beam information of the SRS may be any one of the following:
a spatial filter for uplink transmission of an SRS resource;
a reference signal of the SRS resource; and
a source reference signal of the SRS resource.

Optionally, the SRS may include any one of the following:
an SRS for antenna switching;
an SRS for codebook-based uplink transmission;
an SRS for non-codebook based uplink transmission; and
an SRS for beam management.

Optionally, the first MAC CE may be used to indicate at least one of the following:
identification information of the SRS resource set;
beam information of the SRS resource set;
a PLRS of the SRS resource set;
a power control parameter group of the SRS resource set;
index information of at least one SRS resource;
beam information of at least one SRS resource;
a PLRS of at least one SRS resource;
a power control parameter group of at least one SRS resource;
a type of the SRS; or
a reference signal type.

Optionally, the power control parameter information of the SRS includes at least one of a PLRS or a power control parameter group. The power control parameter group includes at least one of the following: a target received power P0, a path loss compensation factor α, a closed loop power control index, or a power control adjustment state value.

In this embodiment of this application, a parameter determining apparatus is provided, in a unified transmission configuration indicator framework, the apparatus determines at least one of beam information of the SRS or power control parameter information of the SRS, so that the network device and the terminal device can have consistent understanding for the beam and/or the power control parameter of the SRS. In this way, beam alignment and/or accuracy of power control can be ensured.

The parameter determining apparatus in this embodiment of this application may be an apparatus or an apparatus or electronic device with an operating system, or may be a component, an integrated circuit, or a chip in a terminal. The apparatus or electronic device may be a mobile terminal, or a non-mobile terminal. For example, the mobile terminal may include but is not limited to the types of the foregoing listed terminal device 11, and the non-mobile terminal may be a server, a network attached storage (NAS), a personal computer (PC), a television (TV), a teller machine, or a self-service machine. This is not limited in the embodiments of this application.

The parameter determining apparatus provided in this embodiment of this application can implement the processes implemented in the method embodiment of FIG. 2, and a same technical effect can be achieved. To avoid repetition, details are not described herein again.

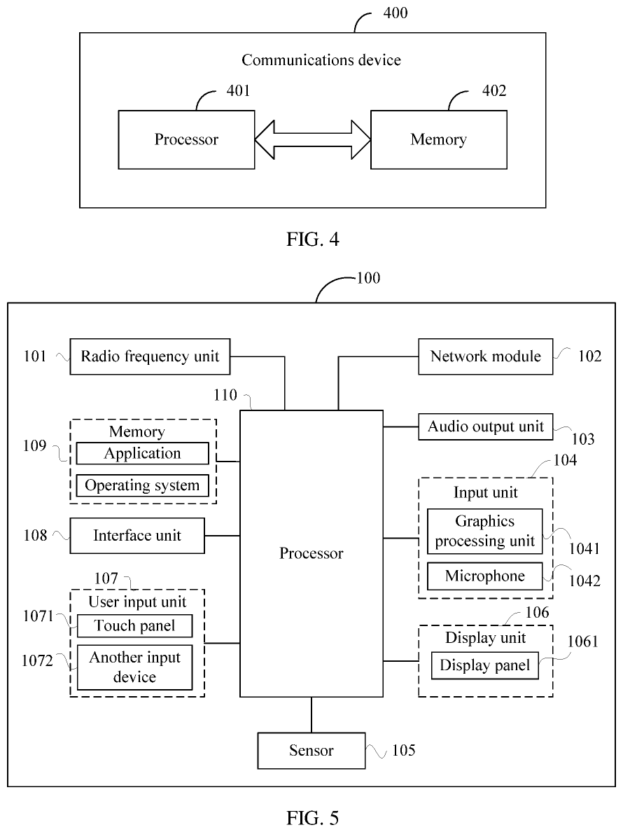

Optionally, as shown in FIG. 4, an embodiment of this application further provides a communications device 400, including a processor 401, a memory 402, and a program or an instruction stored in the memory 402 and executable on the processor 401. For example, when the communications device 400 is a terminal device, the program or the instruction is executed by the processor 401 to implement the processes of the foregoing parameter determining method embodiment, and a same technical effect can be achieved. When the communications device 400 is a network device, the program or the instruction is executed by the processor 401 to implement the processes of the foregoing parameter determining method embodiment, and a same technical effect can be achieved. To avoid repetition, details are not described herein again.

An embodiment of this application further provides a terminal device, including a processor and a communications interface. The processor is configured to determine configuration information of an SRS in a unified transmission configuration indicator framework, where the configuration information of the SRS includes at least one of beam information of the SRS or power control parameter information of the SRS. The terminal device embodiment is corresponding to the terminal side method embodiment, each implementation process and implementation of the method embodiment can be applied to the terminal device embodiment, and a same technical effect can be achieved. Optionally, FIG. 5 is a schematic diagram of a hardware structure of a terminal device according to an embodiment of this application.

The terminal device 100 includes but is not limited to at least a part of components such as a radio frequency unit 101, a network module 102, an audio output unit 103, an input unit 104, a sensor 105, a display unit 106, a user input unit 107, an interface unit 108, a memory 109, and a processor 110.

It can be understood by a person skilled in the art that the terminal device 100 may further include a power supply (such as a battery) that supplies power to each component. The power supply may be logically connected to the processor 110 by using a power management system, to implement functions such as charging, discharging, and power consumption management by using the power management system. The terminal device structure shown in FIG. 5 constitutes no limitation on the terminal device, and the terminal device may include more or fewer components than those shown in the figure, or combine some components, or have different component arrangements. Details are not described herein.

It should be understood that, in this embodiment of this application, the input unit 104 may include a graphics processing unit (GPU) 1041 and a microphone 1042, and the graphics processing unit 1041 processes image data of a still picture or a video obtained by an image capture apparatus (such as a camera) in a video capture mode or an image capture mode. The display unit 106 may include a display panel 1061, and the display panel 1061 may be configured in a form of a liquid crystal display, an organic light-emitting diode, or the like. The user input unit 107 includes a touch panel 1071 and another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein.

In the embodiments of this application, after receiving downlink data from a network device, the radio frequency unit 101 sends the downlink data to the processor 110 for processing, and sends uplink data to the network device. Usually, the radio frequency unit 101 includes but is not limited to an antenna, at least one amplifier, a transceiver, a coupler, a low noise amplifier, a duplexer, and the like.

The memory 109 may be configured to store a software program or an instruction and various data. The memory 109 may mainly include a program or instruction storage area and a data storage area. The program or instruction storage area may store an operating system, and an application or an instruction required by at least one function (for example, a sound playing function or an image playing function). In addition, the memory 109 may include a high-speed random access memory, and may further include a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory, for example, at least one disk storage device, a flash memory device, or another non-volatile solid-state storage device.

The processor 110 may include one or more processing units. Optionally, an application processor and a modem processor may be integrated into the processor 110, the application processor mainly processes an operating system, a user interface, an application or an instruction, and the like, and the modem processor mainly processes wireless communication, for example, a baseband processor. It can be understood that, alternatively, the modem processor may not be integrated into the processor 110.

The processor 110 is configured to determine configuration information of an SRS in a unified transmission configuration indicator framework, where the configuration information of the SRS includes at least one of beam information of the SRS or power control parameter information of the SRS.

In this embodiment of this application, a terminal device is provided, in a unified transmission configuration indicator framework, by determining at least one of beam information of the SRS or power control parameter information of the SRS, the network device and the terminal device can have consistent understanding for the beam and/or the power control parameter of the SRS. In this way, beam alignment and/or accuracy of power control can be ensured.

An embodiment of this application further provides a non-transitory readable storage medium. The non-transitory readable storage medium stores a program or an instruction, and when the program or the instruction is executed by a processor, the processes of the foregoing parameter determining method embodiment are implemented and a same technical effect can be achieved. To avoid repetition, details are not described herein again.

The processor is a processor in the terminal device in the foregoing embodiment. The non-transitory readable storage medium includes a non-transitory computer-readable storage medium, such as a computer read-only memory (ROM), a random access memory (RAM), a magnetic disk, or an optical disc.

An embodiment of this application further provides a chip. The chip includes a processor and a communications interface, the communications interface is coupled to the processor, and the processor is configured to run a program or an instruction to implement the processes of the foregoing parameter determining method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to such process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be a mobile phone, a computer, a server, an air-conditioner, a network device, or the like) to perform the method described in the embodiments of this application.

The embodiments of this application are described above with reference to the accompanying drawings, but this application is not limited to the above implementations, and the above implementations are only illustrative and not restrictive. Under the enlightenment of this application, those of ordinary skill in the art can make many forms without departing from the purpose of this application and the protection scope of the claims, all of which fall within the protection of this application.

What is claimed is:

1. A parameter determining method, wherein the method comprises:
determining configuration information of a sounding reference signal (SRS) in a unified transmission configuration indicator framework, wherein the configuration information of the SRS comprises at least one of beam information of the SRS or power control parameter information of the SRS.

2. The method according to claim 1, wherein the configuration information of the SRS comprises the beam information of the SRS; and
the beam information of the SRS is determined based on any one of following:
using common beam information indicated by a network device, wherein the common beam information is further used for a physical uplink control channel (PUCCH) and/or a physical uplink shared channel (PUSCH);
using first beam information different from the common beam information, wherein the first beam information and the common beam information are selected by the network device from a transmission configuration indicator state pool;
using beam information of the SRS in an SRS resource set indicated by a first media access control control element (MAC CE);
using beam information of the SRS indicated by the first MAC CE; and
using spatial relation information indicated by radio resource control (RRC) or a second MAC CE.

3. The method according to claim 1, wherein the configuration information of the SRS comprises the power control parameter information of the SRS, and the power control parameter information of the SRS comprises a path loss reference signal (PLRS) of the SRS; and
the PLRS of the SRS is determined based on any one of following:
using a first PLRS, wherein the first PLRS is configured in common beam information indicated by a network device or is associated with the common beam information, and the first PLRS is further used for a physical uplink control channel (PUCCH) and/or a physical uplink shared channel (PUSCH);
using a second PLRS, wherein the second PLRS is configured in the common beam information or is associated with the common beam information, and the second PLRS is different from the first PLRS;
using a third PLRS, wherein the third PLRS is configured in first beam information or is associated with the first beam information, the first beam information is different from the common beam information, and the first beam information and the common beam information are selected by the network device from a transmission configuration indicator state pool;
using a PLRS of the SRS in an SRS resource set indicated by a first media access control control element (MAC CE);
using a PLRS of the SRS indicated by the first MAC CE;
using a PLRS configured by radio resource control (RRC), or using a PLRS configured by the RRC and updated by a MAC CE; and
a PLRS that is determined based on whether the common beam information is used, wherein the common beam information is further used for the PUCCH and/or the PUSCH.

4. The method according to claim 1, wherein the configuration information of the SRS comprises the power control parameter information of the SRS, the power control parameter information of the SRS comprises a power control parameter group of the SRS, and the power control parameter group comprises at least one of: a target received power P0, a path loss compensation factor α, a closed loop power control index, or a power control adjustment state value; and
the power control parameter group of the SRS is determined based on any one of following:
using a first power control parameter group, wherein the first power control parameter group is configured in common beam information indicated by a network device or is associated with the common beam information, and the first power control parameter group is further used for a physical uplink control channel (PUCCH) and/or a physical uplink shared channel (PUSCH);
using a second power control parameter group, wherein the second power control parameter group is configured in the common beam information or is associated with the common beam information, and the second power control parameter group is different from the first power control parameter group;
using a third power control parameter group, wherein the third power control parameter group is configured in first beam information or is associated with the first beam information, the first beam information is different from the common beam information, and the first beam information and the common beam information are selected by the network device from a transmission configuration indicator state pool;
using a power control parameter group of the SRS in an SRS resource set indicated by a first media access control control element (MAC CE);
using a power control parameter group of the SRS indicated by the first MAC CE;
using a power control parameter group configured by radio resource control (RRC); and
a power control parameter group that is determined based on whether the common beam information is used, wherein the common beam information is further used for the PUCCH and/or the PUSCH.

5. The method according to claim 2, wherein
the PUCCH is all of PUCCHs or a part of the PUCCHs; and
the PUSCH is a dynamic grant PUSCH or a configured grant PUSCH;
or,
the common beam information is uplink beam information, and the uplink beam information is a separate uplink (UL) transmission configuration indicator (TCI) state or a joint transmission configuration indicator state indicated through a MAC CE or downlink control information (DCI);
or,
the first MAC CE is used to indicate at least one of:
identification information of the SRS resource set;
beam information of the SRS resource set;
a path loss reference signal (PLRS) of the SRS resource set;
a power control parameter group of the SRS resource set;
index information of at least one SRS resource;
beam information of at least one SRS resource;
a PLRS of at least one SRS resource;
a power control parameter group of at least one SRS resource;
a type of the SRS; or
a reference signal type.

6. The method according to claim 3, wherein
the PUCCH is all of PUCCHs or a part of the PUCCHs; and
the PUSCH is a dynamic grant PUSCH or a configured grant PUSCH;
or,
the common beam information is uplink beam information, and the uplink beam information is a separate uplink (UL) transmission configuration indicator (TCI) state or a joint transmission configuration indicator state indicated through a MAC CE or downlink control information (DCI);
or,
the first MAC CE is used to indicate at least one of:
identification information of the SRS resource set;
beam information of the SRS resource set;
a PLRS of the SRS resource set;
a power control parameter group of the SRS resource set;
index information of at least one SRS resource;
beam information of at least one SRS resource;
a PLRS of at least one SRS resource;
a power control parameter group of at least one SRS resource;
a type of the SRS; or
a reference signal type.

7. The method according to claim 4, wherein
the PUCCH is all of PUCCHs or a part of the PUCCHs; and
the PUSCH is a dynamic grant PUSCH or a configured grant PUSCH;
or,
the common beam information is uplink beam information, and the uplink beam information is a separate uplink (UL) transmission configuration indicator (TCI) state or a joint transmission configuration indicator state indicated through a MAC CE or downlink control information (DCI);
or,
the first MAC CE is used to indicate at least one of:
identification information of the SRS resource set;
beam information of the SRS resource set;
a path loss reference signal (PLRS) of the SRS resource set;
a power control parameter group of the SRS resource set;
index information of at least one SRS resource;
beam information of at least one SRS resource;
a PLRS of at least one SRS resource;
a power control parameter group of at least one SRS resource;
a type of the SRS; or
a reference signal type.

8. The method according to claim 1, wherein the beam information of the SRS is any one of following:
a spatial filter for uplink transmission of an SRS resource;
a reference signal of the SRS resource; and
a source reference signal of the SRS resource.

9. The method according to claim 1, wherein the SRS comprises any one of following:
an SRS for antenna switching;
an SRS for codebook-based uplink transmission;
an SRS for non-codebook based uplink transmission; and
an SRS for beam management.

10. The method according to claim 1, wherein the power control parameter information of the SRS comprises at least one of a path loss reference signal (PLRS) or a power control parameter group, wherein
the power control parameter group comprises at least one of: a target received power P0, a path loss compensation factor α, a closed loop power control index, or a power control adjustment state value.

11. A terminal device, comprising a processor, a memory, and a program or an instruction stored in the memory and executable on the processor, wherein the program or the instruction, when executed by the processor, causes the terminal device to perform:
determining configuration information of a sounding reference signal (SRS) in a unified transmission configuration indicator framework, wherein the configuration information of the SRS comprises at least one of beam information of the SRS or power control parameter information of the SRS.

12. The terminal device according to claim 11, wherein the configuration information of the SRS comprises the beam information of the SRS; and
the beam information of the SRS is determined based on any one of following:
using common beam information indicated by a network device, wherein the common beam information is further used for a physical uplink control channel (PUCCH) and/or a physical uplink shared channel (PUSCH);
using first beam information different from the common beam information, wherein the first beam information and the common beam information are selected by the network device from a transmission configuration indicator state pool;
using beam information of the SRS in an SRS resource set indicated by a first media access control control element (MAC CE);
using beam information of the SRS indicated by the first MAC CE; and
using spatial relation information indicated by radio resource control (RRC) or a second MAC CE.

13. The terminal device according to claim 11, wherein the configuration information of the SRS comprises the power control parameter information of the SRS, and the power control parameter information of the SRS comprises a path loss reference signal (PLRS) of the SRS; and
the PLRS of the SRS is determined based on any one of following:
using a first PLRS, wherein the first PLRS is configured in common beam information indicated by a network device or is associated with the common beam information, and the first PLRS is further used for a physical uplink control channel (PUCCH) and/or a physical uplink shared channel (PUSCH);
using a second PLRS, wherein the second PLRS is configured in the common beam information or is associated with the common beam information, and the second PLRS is different from the first PLRS;
using a third PLRS, wherein the third PLRS is configured in first beam information or is associated with the first beam information, the first beam information is different from the common beam information, and the first beam information and the common beam information are selected by the network device from a transmission configuration indicator state pool;
using a PLRS of the SRS in an SRS resource set indicated by a first media access control control element (MAC CE);
using a PLRS of the SRS indicated by the first MAC CE;
using a PLRS configured by radio resource control (RRC), or using a PLRS configured by the RRC and updated by a MAC CE; and
a PLRS that is determined based on whether the common beam information is used, wherein the common beam information is further used for the PUCCH and/or the PUSCH.

14. The terminal device according to claim 11, wherein the configuration information of the SRS comprises the power control parameter information of the SRS, the power control parameter information of the SRS comprises a power control parameter group of the SRS, and the power control parameter group comprises at least one of: a target received power P0, a path loss compensation factor α, a closed loop power control index, or a power control adjustment state value; and
the power control parameter group of the SRS is determined based on any one of following:
using a first power control parameter group, wherein the first power control parameter group is configured in common beam information indicated by a network device or is associated with the common beam information, and the first power control parameter group is further used for a physical uplink control channel (PUCCH) and/or a physical uplink shared channel (PUSCH);
using a second power control parameter group, wherein the second power control parameter group is configured in the common beam information or is associated with the common beam information, and the second power control parameter group is different from the first power control parameter group;
using a third power control parameter group, wherein the third power control parameter group is configured in first beam information or is associated with the first beam information, the first beam information is different from the common beam information, and the first beam information and the common beam information are selected by the network device from a transmission configuration indicator state pool;
using a power control parameter group of the SRS in an SRS resource set indicated by a first media access control control element (MAC CE);
using a power control parameter group of the SRS indicated by the first MAC CE;
using a power control parameter group configured by radio resource control (RRC); and
a power control parameter group that is determined based on whether the common beam information is used, wherein the common beam information is further used for the PUCCH and/or the PUSCH.

15. The terminal device according to claim 12, wherein
the PUCCH is all of PUCCHs or a part of the PUCCHs; and
the PUSCH is a dynamic grant PUSCH or a configured grant PUSCH;
or,
the common beam information is uplink beam information, and the uplink beam information is a separate uplink (UL) transmission configuration indicator (TCI) state or a joint transmission configuration indicator state indicated through a MAC CE or downlink control information (DCI);
or,
the first MAC CE is used to indicate at least one of:
identification information of the SRS resource set;
beam information of the SRS resource set;
a path loss reference signal (PLRS) of the SRS resource set;
a power control parameter group of the SRS resource set;
index information of at least one SRS resource;
beam information of at least one SRS resource;
a PLRS of at least one SRS resource;
a power control parameter group of at least one SRS resource;
a type of the SRS; or
a reference signal type.

16. The terminal device according to claim 13, wherein
the PUCCH is all of PUCCHs or a part of the PUCCHs; and
the PUSCH is a dynamic grant PUSCH or a configured grant PUSCH;
or,
the common beam information is uplink beam information, and the uplink beam information is a separate uplink (UL) transmission configuration indicator (TCI) state or a joint transmission configuration indicator state indicated through a MAC CE or downlink control information (DCI);
or,
the first MAC CE is used to indicate at least one of:
identification information of the SRS resource set;
beam information of the SRS resource set;
a PLRS of the SRS resource set;
a power control parameter group of the SRS resource set;
index information of at least one SRS resource;
beam information of at least one SRS resource;
a PLRS of at least one SRS resource;
a power control parameter group of at least one SRS resource;
a type of the SRS; or
a reference signal type.

17. The terminal device according to claim 14, wherein
the PUCCH is all of PUCCHs or a part of the PUCCHs; and
the PUSCH is a dynamic grant PUSCH or a configured grant PUSCH;
or,
the common beam information is uplink beam information, and the uplink beam information is a separate uplink (UL) transmission configuration indicator (TCI) state or a joint transmission configuration indicator state indicated through a MAC CE or downlink control information (DCI);
or,
the first MAC CE is used to indicate at least one of:
identification information of the SRS resource set;
beam information of the SRS resource set;
a path loss reference signal (PLRS) of the SRS resource set;
a power control parameter group of the SRS resource set;
index information of at least one SRS resource;
beam information of at least one SRS resource;
a PLRS of at least one SRS resource;
a power control parameter group of at least one SRS resource;
a type of the SRS; or
a reference signal type.

18. The terminal device according to claim 11, wherein the beam information of the SRS is any one of following:
a spatial filter for uplink transmission of an SRS resource;
a reference signal of the SRS resource; and
a source reference signal of the SRS resource;
or,
the SRS comprises any one of following:
an SRS for antenna switching;
an SRS for codebook-based uplink transmission;
an SRS for non-codebook based uplink transmission; and
an SRS for beam management.

19. The terminal device according to claim 11, wherein the power control parameter information of the SRS comprises at least one of a path loss reference signal (PLRS) or a power control parameter group, wherein
the power control parameter group comprises at least one of: a target received power P0, a path loss compensation factor α, a closed loop power control index, or a power control adjustment state value.

20. A non-transitory readable storage medium, wherein the non-transitory readable storage medium stores a program or an instruction, and the program or the instruction, when executed by a processor of a terminal device, causes the terminal device to perform:
determining configuration information of a sounding reference signal (SRS) in a unified transmission configuration indicator framework, wherein the configuration information of the SRS comprises at least one of beam information of the SRS or power control parameter information of the SRS.
